(19) United States
(12) Patent Application Publication
(10) Pub. No.: US 2007/0160783 A1
(43) Pub. Date: Jul. 12, 2007

(54) Food casing based on regenerated cellulose with a fully synthetic fiber reinforcement

(75) Inventors: Theresia Rieser, Eppelsheim (DE); Walter Lutz, Budenheim (DE); Kallc Gmbh, Wiesbaden (DE)

Correspondence Address: PROPAT, L.L.C., 425-C SOUTH SHARON AMITY ROAD, CHARLOTTE, NC, 28211-2841, US

(73) Assignee: KALLE GMBH, WIESBADEN GERMANY (DE)

(21) Appl. No.: 11/587,840

(22) PCT Filed: May 6, 2005
(86) PCT No.: PCT/EP05/04919

§ 371 Date: Oct. 26, 2006

(30) Foreign Application Priority Data
May 10, 2004 (DE) 10-2004-002-975.9

(51) Int. Cl. A22C 13/00

(52) U.S. Cl. 428/34.8

(57) ABSTRACT

The invention relates to a foodstuff casing based on regenerated cellulose with a reinforcement made of synthetic fibers, to the use thereof as a synthetic sausage casing, and to methods for the production thereof. The synthetic fibers are made of thermoplastic materials, preferably polyolefins or copolymers with olefin units, polyacrylates, copolymers with acrylonitrile units, polyesters or copolyesters and/or aliphatic or (partially) aromatic polyamides or copolyamides.

The invention relates to a food casing based on regenerated cellulose with a fiber reinforcement. It relates in addition to the use of the food casing as artificial sausage casing.

Synthetic skins based on regenerated cellulose that are reinforced with a fibrous paper strong when wet have long been part of the art (see G. Effenberger, Wursthüllen-Kunstdarm, Holzmann Buchverlag, Bad Wörishofen, 2^{nd} ed. [1991], pp. 23/24). The production of these casings, also referred to as fibrous skins, generally involves the use of a nonwoven web of cellulosic fibers, in particular a hemp fiber web. The fiber web is cut into strips whose width corresponds to the caliber of the fibrous skins to be produced. In a fibrous-skin spinning machine the strips are each formed into a tube with an overlapping longitudinal seam, and this tube is then passed through an annular die with annular slit. Via the die, viscose is applied to the fiber-web tube from the outside, from the inside or from both sides. This viscose penetrates the fiber web. The externally, internally or doubly viscose-treated tube is then passed through acidic precipitating baths, in which the cellulose is regenerated from the viscose. Subsequently the tube passes additionally through washing baths, and possibly plasticizer baths as well, and is finally dried. In the finished tubular casing, the overlapping longitudinal edges of the fiber web are joined firmly to one another by the regenerated cellulose. Even an externally viscose-treated tube has on its inside a substantially coherent layer of regenerated cellulose. In comparison to cellulose hydrate skins without fiber reinforcement, fibrous skins in each case exhibit markedly improved caliber consistency and also a higher tensile strength.

The web of cellulosic fibers is typically given wet strength and alkali resistance beforehand through treatment with suitable binders. Those used are, in particular, dilute viscose solutions (containing approximately 3% to 5% by weight of cellulose). The cellulose regenerated from the viscose then binds the fibers of the web. Viscose or cellulose binders require regeneration or precipitation of cellulose, which involves a considerable technical effort. The required wet strength and alkali resistance can also be achieved by treatment with cellulose acetate solution or with resin binders based on polyamide-epichlorohydrin or polyamide-polyamine-epichlorohydrin. The amount of binder must be determined precisely in every case. Fluctuations in the amount of binder can have very severe effects on the stability of the food casings.

Fiber reinforcements formed to a tube and made of cellulosic fibers which have been treated with polyamide-epichlorohydrin binders, polyamide-polyamine-epichlorohydrin binders or other binders, based on secondary or tertiary amines, have a substantial disadvantage if the spinnable cellulose solution or viscose solution is applied only to their outside. This is because the web in that case is frequently no longer fully penetrated by the viscose or cellulose solution, and hence is not fully covered on the inside by a layer of regenerated cellulose. Individual fibers that are not covered are enough, however, to produce relatively severe sticking of the casing to the contents. In many applications this is an unwanted phenomenon. In the art, indeed, the casing is frequently required to be readily peelable from the contents. This is the case, for example, with the production of pizza salami. It means that in the case of such externally viscose-treated casings it is necessary to carry out an additional treatment with an adhesion-lessening impregnation on the inside, which in turn raises the production costs.

Also known are fibrous skins which are produced by the amine oxide process. In that process, instead of the viscose solution, a solution of cellulose in a—generally hydrous—tertiary amine oxide is used. A particularly suitable solvent has proven to be N-methylmorpholine N-oxide, in particular its monohydrate. The cellulose is in purely physical solution in the amine oxide, without any chemical derivatization as in the viscose process. The coating of the fiber web material, formed into a tube, then takes place, again, using annular-slit dies, essentially as in the viscose process. Instead of the regeneration in acidic baths containing sulfuric acid, however, precipitation takes place in a bath—frequently a chilled bath—of a dilute aqueous amine oxide.

Besides the hemp fiber paper that is frequently used, fiber webs comprising a mixture of cellulose fibers and synthetic fibers have also been disclosed as a reinforcement for tubular food casings based on regenerated cellulose (WO 00/40092). These fiber webs are said to have the advantage that the stretch in the transverse direction on contact with moisture is more uniform over the width of the nonwoven web; in other words, the web does not stretch substantially more at the edges than in the middle.

Also known, finally, are tubular food casings based on cellulose hydrate which have a fiber paper web of cellulosic fibers as their reinforcement, in combination with a textile material, such as a woven fabric or knit made of wool, cotton, cellulose, polyamide, polyester, polyacrylonitrile or polypropylene (DE-A 38 26 616=U.S. Pat. No. 5,043,194). The woven fabric or knit forms a laminate, for example, together with the fiber paper web. As in the case of the fibrous skins already described, it is almost completely embedded in regenerated cellulose. In a further embodiment the textile material on its own forms the reinforcement. In this case the textile material is composed of cellulosic fibers (especially cotton fibers), or alternatively of blends of cellulosic fibers with synthetic fibers (such as polyamide or polyester fibers). In general the layer of cellulose hydrate on the outside of the casings is kept sufficiently thin that the textile reinforcing material is still readily visible. In that case the casings have a particularly high-value effect. They are used in particular for dry or semi-dry (long-keeping) sausage varieties, such as salami.

Melt-spun synthetic nonwoven webs whose consolidation takes place typically by thermal or chemical action generally have a high mechanical strength but a low porosity. This means that they are penetrated only with great difficulty by viscose or cellulose solutions. For this reason they have been considered unsuitable as a fiber reinforcement in cellulose-based food casings.

The object, then, was to eliminate the above-described disadvantages of the known, fiber-reinforced food casings based on regenerated cellulose. The intention in particular was to improve such casings in such a way that they are attacked to a lesser extent by cellulases, i.e., by cellulytic enzymes of the kind occurring in particular in (true) mold. A further intention is that the tubular casings should have a very uniform diameter over their entire length; in other words, that the casings should have a high caliber consistency.

These objects have been achieved with a sheetlike structure made from purely synthetic fiber material that serves as an internal reinforcement to the food casing.

The present invention accordingly provides a food casing based on regenerated cellulose with an internal fiber reinforcement, wherein the fiber reinforcement is composed of synthetic fibers.

The synthetic fibers can be produced from plastics, which in turn are obtainable by addition polymerization, polycondensation or polyaddition. The plastics are brought into a spinnable form by dissolution or melting, for example, and are spun using appropriate dies. Wet-spun fibers are consolidated in a precipitating bath, dry-spun fibers using air. The synthetic fibers may be composed for example of thermoplastics, such as of polyolefins (especially polyethylene or polypropylene) or copolymers with olefin units, polyacrylates, copolymers with acrylonitrile units, polyesters (especially polyethylene terephthalate or polybutylene terephthalate) or copolyesters and/or aliphatic or (part-)aromatic polyamides or copolyamides (specially nylon 4, nylon 6, nylon 7, nylon 11, nylon 12, nylon 4,6, nylon 6,6, nylon 6,10, or nylon 6I/6T). Polyacrylate fibers (especially fibers of acrylonitrile or acrylonitrile copolymers having preferably vinyl acetate and/or vinylpyrrolidone as their comonomer units) are typically spun from a polymer solution and consolidated by precipitation in a precipitating bath. By “copolymer”, “copolyamide”, etc., the intention is in each case to refer to polymers which have two or more different monomer units.

The polymer fibers may also be what are called bicomponent or multicomponent fibers (see Franz Fourné, Synthetische Fasern, Carl Hanser Verlag [1995], pp. 539-549). In the course of the production of these fibers, two or more different polymers are spun with one another in the same way. In this way it is possible to produce, for example, fibers having a polyester fraction and a polyamide fraction. The bicomponent or multicomponent fibers include, in particular, side-by-side types, core-sheath types and matrix-fibril types. Different bicomponent or multicomponent fibers can be blended with one another or else with monocomponent fibers.

The synthetic fibers preferably form a nonwoven web, a woven fabric or a knit. Webs in the context of the present invention are sheetlike structures produced not by the conventional method of fabric binding with warp and weft or by loop forming, but instead by intertwining and/or cohesive and/or adhesive joining of fibers. Webs may be produced from spun fibers or from filaments (continuous fibers, as they are known). Within the web the fibers may have a preferential direction (oriented webs) or may be unoriented (random-laid webs). The webs can be consolidated mechanically by needling, interlooping or by entangling using sharp jets of water, which is referred to as spunlacing (water-jet consolidation or hydroentanglement). The webs may also contain fibers differing in their chemical nature.

Adhesive consolidation comes about through the chemical crosslinking of the fibers with binders or by melting and/or dissolution of what are called binder fibers, which are mixed into the web in the course of its production. Ultrasound consolidation is also known. In the case of cohesive crosslinking, the surfaces of the fibers are partly dissolved by means of suitable chemicals and are joined under pressure or fused at elevated temperature. Spunbonded webs are formed by spinning, subsequent laydown, blow up or suspension of fibers, known as spunbonding.

Spunbonding and spunlacing can also be combined. This makes it possible to obtain multilayer webs and/or multiphase webs. These may have different fiber materials and/or blends of different fibers within one layer or phase.

Two-layer or two-phase webs can also be obtained if a melt-spun web is the starting point and a further web is produced on it by melt spinning. In this way it is also possible to produce webs having an even greater number of layers and/or phases. It is likewise readily possible to apply wet-laid or dry-laid fibers to a melt-spun web of synthetic fibers, or vice versa. Finally, it is also possible to carry out subsequent adhesive or cohesive linking of webs of different chemical type to one another. The multilayer and multiphase webs generally have particularly advantageous properties, in particular a high porosity in conjunction with high strength and flexibility. Within the multilayer or multiphase webs there are regions in which one fiber type occurs preferentially in comparison to at least one further fiber type.

Alternatively the webs can be produced in single-layer form. In this case, fibers alike or different in chemical nature are distributed, largely uniformly, in the web. As far as the invention is concerned it is irrelevant whether the webs in question are single-layer, multilayer or multiphase webs.

A further possibility is to admix chemical binders to the synthetic webs. These are, for example, binders such as polyamide-epichlorohydrin-based resin binders, polyvinylamines, polyalkylenimines or latex binders.

Particularly suitable for producing the food casings of the invention are fully synthetic webs consolidated by spunlacing and/or by thermal aftertreatment. An additional possibility is the use of a latex-based binder, which should not adversely affect the capacity for the web to be penetrated by spinnable viscose or cellulose solutions.

Suitable binders are those based on polystyrenes, carboxylated polystyrenes, polyvinyl alcohols or polyacrylates, polyurethane-based resins, copolymers based on polystyrene and acrylic esters, copolymers based on butadiene and styrene and/or acrylonitrile, epoxy-based resins or urea-formaldehyde condensation products, and other products known to the skilled worker. In the case of hydrophilic binder systems, moreover, ionic, nonionic or zwitterionic surface-active components, surfactants for example, are frequently added to the binder, or the synthetic sheetlike structures are treated with surface-active substances prior to the application of binder. The surface-active components improve the wetting of the filaments or fibers with the binder.

The binders can be applied during the production operation with the aid of what is known as a size press, but can also be applied by spraying, dipping or roller application.

Surprisingly it has emerged that the spunlacing method and/or a gentle thermal aftertreatment of webs to which, for example, binder fibers with a relatively low melting point have been added leads to webs of sufficient stability and porosity, so that effective penetration of the synthetic sheetlike structure with viscose or cellulose solutions is possible.

Also suitable for use as essentially two-dimensional fiber reinforcement in the food casing of the invention, however, are loop-formed or loop-drawn fabrics or woven fabrics made from synthetic fibers. In the case of loop-drawn or loop-formed fabrics they are composed of looped threads joined in mesh fashion. Woven fabrics are formed from threads which are crossed at right angles.

Not only webs but also woven fabrics, loop-drawn knits or loop-formed knits of the type specified above are generally already of sufficient wet strength and alkali resistance. In order further to improve the wettability of the sheetlike fiber reinforcement with viscose or cellulose solutions, their surface can be additionally modified, using high-energy radiation, for example. This can be achieved by treatment with corona discharge, plasma or electron beams or by other methods known to the skilled worker.

An improvement in the wettability can also be accomplished by chemically modifying the sheetlike structures. By way of example it is possible for this purpose to employ the binders already specified, which increase the hydrophilicity of the fibers or filaments made from synthetic polymers. It is also possible to use a self-crosslinking, water-based acrylate emulsion (obtainable, for example, from the company Rohm & Haas under the designation ®Rhoplex NW 2744 F).

The basis weight of the dry webs is 10 to 50 g/m², 15 to 30 g/m², preferably 17 to 26 g/m².

The basis weight of the sheetlike structures based on woven fabrics, loop-drawn knits or loop-formed knits, constructed from fibers of like or different chemical nature, is situated in the range from 10 to 400 g/m², preferably in the range from 25 to 110 g/m².

The time in which the fiber reinforcement made from synthetic fibers is penetrated by the viscose or cellulose spinning solution (viscose penetration time) is generally 5 to 120 s, preferably 10 to 80 s, more preferably 20 to 40 s, and is also dependent on the viscosity of the spinning solution.

The singly or double-sidedly viscose-treated, fully synthetic sheetlike structures and the food casings of cellulose can be provided by methods known to the skilled worker with additional enhancement components as already described.

A fiber reinforcement made from synthetic fibers brings with it a number of advantages: synthetic fibers are cheap and available in consistent quality from numerous suppliers. They are, furthermore, not attacked by cellulytic enzymes (cellulases). Casings based on cellulose hydrate with a cellulosic fiber reinforcement, in contrast, can be completely destabilized by exposure to cellulases, so that the contents perish. Synthetic fiber reinforcements, moreover, possess a high mechanical stability. The majority of them are also stable to alkali. This is so for polyolefins, for example.

The food casing of the invention possesses, moreover, a high mechanical stability and also a high caliber stability. The caliber stability is determined essentially by the swelling properties of the sheetlike fiber reinforcement in the transverse direction (i.e., in the direction perpendicular to the machine direction). For the usefulness of the sausage casing in industrial sausage manufacture it is of critical importance. Particularly in the case of pizza salami production, the industry frequently requires a fluctuation in sausage diameter of less than 1 mm. The swelling properties of the purely synthetic sheetlike structures in water are generally much lower than in the case of cellulose-based fiber paper. Consequently a reinforcement of the food casing with purely synthetic sheetlike structures implies a significant gain for the quality of the finished food casing in the area of the dimensional fluctuations of the finished casing, and hence also an improvement in the quality of the end-product foodstuff.

The food casing of the invention can be produced by methods which are known in principle to the skilled worker. These methods differ essentially in the nature and the preparation of the spinnable cellulose solutions. In the case of the very widespread viscose method, the cellulose is treated with sodium hydroxide solution and carbon disulfide and then converted into alkali-soluble cellulose xanthogenate. The viscose solution which is formed is applied to the sheetlike fiber reinforcements after they have been formed into a tube. The cellulose xanthogenate is subsequently converted (regenerated) into what is called regenerated cellulose, under the action of sulfuric acid. The tubes are cleaned from by-products and residues of acid in a series of washing baths. At the end of the baths section there is typically a vat containing a secondary plasticizer (that is, a plasticizer which can be removed by washing), especially glycerol. The end of the production line is formed by a drying operation for the removal of excess water from the gel tube. The dried tube is then advantageously wound to form rolls. Subsequently it can be configured, by being shirred into sticks or processed into sections which are closed at one end, for example.

In the case of the second method, the cellulose is brought directly into solution by exposure to specific solvents or complexing agents. On the basis of its currency for the production of sausage casings, mention will be made here only of the NMMO method. This method is based on the solubility of cellulose in tertiary amine oxides such as N-methylmorpholine N-oxide, for example. The enhancement steps have already been described for the viscose method and can be integrated similarly into the NMMO method.

By means of the stated methods it is possible to produce fiber casings or textile casings based on cellulose. For the invention the nature of the preparation, and the spinnable cellulose or cellulose-derivative solutions that are used, are unimportant. The fully synthetic sheetlike structures can be coated either singly (from the inside or from the outside) or else double-sidedly with viscose or cellulose solution. The configuration of the casings following the method in each case may include simple rolling up, cutting into sections and binding of one end of the sections, or shirring of the roll product to form sticks. It is also possible for the roll product to be printed.

The properties of the casing can be modified by means of additives which are metered into the viscose or cellulose solution before it is applied to the fiber reinforcement. Examples of such additives include organic or inorganic dyes or color pigments, polymeric additives, examples being alginates, polyvinyl-pyrrolidone, copolymers of N-vinylpyrrolidone and dimethylaminomethyl methacrylate or copolymers of N-vinylpyrrolidone and trimethylmethacryloyloxyalkylammonium halide, trimethylmethacryloyloxyalkylammonium alkanesulfonate or trimethylmethacryloyloxyalkylammonium sulfate, polyethylene oxides, fats or fatlike substances, as described in EP-A 0 638 241. The aforesaid polymeric additives act at the same time as primary plasticizers (that is, plasticizers which have a permanent action, since they cannot be washed out). The fraction of the polymeric additives can range up to about 40% by weight, based on the weight of the cellulose in the coating solution.

In a further embodiment, viscose-treated woven or knitted textile fabrics are formed into a tubular structure only after the operations of coating with viscose or cellulose solution and subsequent regeneration of the cellulose. In that case the fixing of the seam along the longitudinal side takes place, for example, by adhesive bonding, preferably with a polyurethane adhesive. In addition it is possible for the longitudinal seam to be permanently fixed by stitching, sealing or other joining techniques.

Furthermore, the food casing of the invention can be coated or impregnated internally and/or externally. The coating in question may be, for example, a continuous coating with barrier properties for oxygen and/or water vapor. A coating particularly suitable for this purpose is one comprising polyvinylidene chloride (PVDC) or a vinylidene chloride copolymer (DE-A 197 42 719). The impregnation or coating may also comprise, finally, liquid smoke, other flavors, proteins (which may or may not be crosslinked), biocides, organic or inorganic particles, polyamide-based resins, oils or waxes, or similar additives.

The impregnation or coating can be applied to the outside in-line by roller application, spraying or dipping. In the case of sheetlike textile structures which have not been formed into a tube, it is also possible for both sides to be modified where appropriate. The treatment of the outer casing surface may also not take place until during configuration. Impregnation or coating of the inner surface of the tubular casing takes place advantageously by wetting of the surface with a solution. This can be done by filling the gel tube or the dried casing with a corresponding impregnating solution. The impregnation of the inside can also be accomplished by internal mandrel spraying at the same time as the shirring of the food casing.

Using the means described it is possible in particular to control how strongly or weakly the casing adheres to the sausage meat. The adhesion can also be custom-tailored by the type or the concentration or by way of the mixing of different adhesion components and peeling components (DE 609 129, DE 12 92 708). A particularly low level of adhesion to the sausage meat can be achieved by means of what are called peeling components on the inner casing surface that have little or no affinity for the meat. Typical examples are alkylketene dimers, chromium-fatty acid complexes, oils and waxes (EP-B 0 006 551). To improve the adhesion of the casing to the sausage meat it is possible to use cationic resins based on polyamidoamine, epichlorohydrin or melamine-formaldehyde and/or proteins which have been treated with crosslinkers, such as glyoxal or glutaraldehyde.

In the case of light-colored fiber casings, and particularly in the case of white fiber casings, there is frequently a discoloration of the casing surface. This effect can be attenuated, or prevented entirely, if the impregnation or coating comprises δ-gluconolactone or agents having a similar activity.

The food casings produced in accordance with the invention are suitable in particular for use as artificial sausage casing, particularly for producing raw-meat sausage, cooked-meat sausage or scalded-emulsion sausage. Provided the casings are sufficiently permeable, the sausages can also be smoked if required. The casing can also be used in the production of cheese.

The examples which follow serve to illustrate the invention. Percentages in these examples are by weight, unless indicated otherwise or immediately apparent from the context.

The “viscose penetration time” specified in table 4 refers to the time taken for the viscose to penetrate into the sheetlike fiber reinforcement. In the laboratory this time was measured as follows: the sheetlike reinforcement was clamped into a ring. Ammonium sulfate was sprinkled on the reinforcement, after which the clamped reinforcement was placed on a glass vessel which had been filled with viscose. The glass vessel had been filled with the viscose in such a way that the side of the reinforcement facing away from the ammonium sulfate was completely wetted with viscose.

The moment of complete penetration was indicated by the evolution of ammonia (as a result of the action of sodium hydroxide from the viscose on ammonium sulfate). The formation of ammonia can easily be detected by the color change of a moistened pH paper. For this purpose the pH paper is held at a distance of 1 cm above the ammonium sulfate salt. The time from the first contact of the two-dimensional reinforcement with viscose to the first discoloration of the pH paper was measured. From 10 individual measurements the viscose penetration time was reported as an average. The measurement took place at 23° C.

The viscose penetration time is also dependent on the viscosity of the viscose. It can therefore be determined only with a viscose whose viscosity is precisely defined and consistent. The specific viscose solution used was one containing 7.25% by weight of cellulose in the form of cellulose xanthogenate, which in other words had been derivatized with carbon disulfide and NaOH. The falling-ball viscosity (FBV) of the viscose was 223 seconds at 25° C. and was determined as follows:

The viscose was introduced into a glass tube with a defined length. A stopwatch was used to determine the time taken for a standardized steel ball to fall within the defined length. The result obtained is the falling-ball viscosity (FBV) in seconds.

The viscosity was determined using a glass bomb tube with a measuring section of 150 mm and with a rubber ring as mount. The total length of the tube was 300 mm. The distance from the edge of the insertion opening to the topmost annular calibration mark was 100 mm, and the distance from the edge of the insertion opening to the bottommost annular calibration mark was 250 mm. The internal diameter of the tube was 20 mm.

The viscosity measurement was carried out using a class I steel ball according to DIN 5401, having a diameter of 2.5 mm and a weight of 63.8 mg. The ball was degreased using acetone.

A glass thermal conditioning bath with an internally suspended thermostat ensured a constant measurement temperature of 25° C. A perforated plastic plate was used to mount the bomb tube in the thermal conditioning bath (perforation diameter: 25 mm, plastic-plate diameter: 320 mm). A stopwatch was used to measure the falling-ball time along the measurement section.

Avoiding air bubbles as far as possible, the viscose was introduced into the bomb tube to a point at least 3 cm above the topmost annular calibration mark. Thereafter the bomb tube was inserted in vertical suspension into the thermal conditioning bath. The viscose was then conditioned to a temperature of 25° C. (thermal-conditioning time: 20 to 25 minutes).

For the measurement a steel ball was dropped into the center of the thermally conditioned viscose, and a stopwatch was used to measure the time taken (in seconds) for the ball to fall within the defined measurement section of 150 mm. As soon as the lower periphery of the ball appeared to contact the top annular calibration mark (appearing as a line), as viewed from the level of the upper annular calibration mark, a stopwatch was used to determine the beginning and likewise, at the bottommost annular calibration mark, the end of the fall time.

During the measurement period it was ensured that the bomb tube was suspended vertically in the thermal conditioning bath and the ball sank to the bottom in the middle. A single determination was carried out and the ball fall time was recorded as the FBV.

The food casings of the invention were tested in comparison with a food casing which was reinforced with a conventional cellulosic fiber web. The adhesion of the casing to the meat was assessed in accordance with the scale of ratings in table 1.

TABLE 1

| | Scale for rating the adhesion properties of casings | | | | | |
|---|---|---|---|---|---|---|
| | | very | | | | very |
| Adhesion | no | slight | slight | moder- | signif- | signif- |
| proper- | adhe- | adhe- | adhe- | ate | icant | icant |
| ties | sion | sion | sion | adhesion | adhesion | adhesion |
| Rating | 0 | 0.5 | 1 | 1.5-1.75 | 2.0-2.25 | 2.5 |

Raw Sausage Production

A meat emulsion was used which consisted of 70% meat (from the shoulder of the pig) and 30% fat (back fat of the pig), which had been stored at −30° C., and also of 24 g/kg of nitrite curing salt. The water activity (a_{w}) was 0.98-0.99. The pH was 6.0 (measured 24 h after slaughter). The ingredients were comminuted at −5 to 0° C. (pH up to 5.9; a_{w} 0.96 to 0.97). The casing was stuffed at a temperature of −3 to +1° C. Ripening took place after an equilibration time of approximately 6 hours at a temperature of 20 to 25° C. and a relative atmospheric humidity of less than 60% in three sections in a dark room. The ripening sections are shown in table 2.

TABLE 2
Summary of the ripening sections in raw sausage ripening

| Ripening | | Section 1 | Section 2 | Section 3 |
|---|---|---|---|---|
| Room | temperature | 18 to 25° C. | 18 to 22° C. | around 15° C. |
| | rel. humidity | 90 to 92% | 85 to 90% | 75 to 80% |
| | air velocity | 0.5 to 0.8 | 0.2 to 0.5 | 0.05 to 0.1 |
| | [m/sec] | | | |
| Product | pH | 5.2 to 5.6 | 4.8 to 5.2 | 5.0 to 5.6 |
| | a_{w} | 0.94 to 0.96 | 0.90 to 0.94 | 0.85 to 0.92 |
| | ripening time | 3 days | 7 days | 6 weeks |

Scalded-Emulsion/Cooked-Meat Sausage Production

After stuffing with a meat sausage emulsion, the skin was heated at 75° C. The heating time (in minutes) corresponded to the caliber of sausage casing used +10% extra time. For a sausage in a casing of caliber 45, for example, this means that it was cooked for (45 min+4.5 min).

In the examples below, casings were used in the course of whose production a fiber web or a textile material had been formed into a tube which was then coated on one or both sides with viscose. The cellulose was regenerated using dilute sulfuric acid. Thereafter the gel tube was neutralized, provided with a plasticizer, and dried.

In the examples, the modified sides of the fibrous or textile sheetlike structures were on the inside of the food casings which had been formed to a tube. From the initial rolls of the fibrous and textile sheetlike structures, rolls with a width of 145 mm are cut, which are suitable for the production of a sausage casing of caliber 45.

### EXAMPLE 1 (COMPARATIVE)

Fiber Casing with Fiber Reinforcement of Pure Cellulose Web

As a comparison to the casings with fully synthetic reinforcement, a casing was used which had a cellulose-based nonwoven web reinforcement. 100% of the fibers in the web, which possessed wet strength, were abaca fibers (cellulose fibers). The web with wet strength had a basis weight of 19 g/m². The wet strength of the web was achieved by virtue of a customary polyamide-polyamine-epichlorohydrin-based resin binder, which was present at 3% in the web. Using the viscose method, a fiber-reinforced tubular food casing based on cellulose, having a basis weight of approximately 78 g/m², was manufactured using the web. In this case the viscose was applied solely to the outside of the tube-formed web.

### EXAMPLE 2

Fiber Casing with Fully Synthetic Reinforcement

A two-layer web possessing wet strength and featuring one layer of continuous polypropylene fibers and a second layer of continuous bicomponent fibers (polypropylene-polyethylene; side-by-side configuration) was obtained by extruding the bicomponent filaments onto a preformed melt-spun polypropylene web. In the multiphase web the ratio of the bicomponent filaments to the polypropylene filaments was 1:1. The melting point of the polyethylene was about 125° C., that of the polypropylene 162° C. The web was treated, after the extrusion operations, at 145° C. with a “point bonded” calender roll, in order to enhance the binding properties. The total weight of the web was 19 g/m². Using the viscose method, it was used to produce a tubular, cellulose-based food casing having a basis weight of 78 g/m². The viscose was in this case applied solely from the outside to the tube-formed web.

### EXAMPLE 3

Example 2 was repeated except that this time the web from example 2 was additionally treated with a self-crosslinking acrylate emulsion in accordance with table 3, in order to enhance its wetting properties. The application was made before the web was calendered. A total of 5% of acrylate binder was applied, based on the dry weight of the web starting material used. Using the viscose method, the web was then used to produce a tubular, cellulose-based food casing having a basis weight of 82 g/m². The viscose was in this case applied solely from the outside to the tube-formed web.

TABLE 3
Coating formula for the acrylate binder

| Components | Parts by weight |
|---|---|
| Water | 65.74 |
| Octylphenol polyethylene glycol ether | 0.07 |
| (®Triton X-114 from Rohm and Haas) | 0.21 |
| with hot water added | |
| Acrylate emulsion | 33.00 |
| (®Rhoplex NW-2744 F from Rohm and Haas) | |
| Ammonium nitrate (25%) | 0.88 |
| Ammonium hydroxide | to pH 8.0-8.5 |
| Wacker antifoam emulsion SE 2 | 0.10 |
| (Drawin Vertriebs GmbH) | |
| Total | 100.00 |

### EXAMPLE 4

The viscose was applied to the web from example 3, from the outside and from the inside, in a ratio of 80:20, to the tube-formed paper.

### EXAMPLE 5

The web from example 2 was subjected, prior to calendering, to a further consolidation by exposure to “sharp” waterjets (spunlacing). Subsequently the calendering was carried out as in example 2. Using the viscose method, a tubular, cellulose-based food casing with a basis weight of 78 g/m² was produced. The viscose in this case was applied from the outside to the tube-formed web.

### EXAMPLE 6

Fabric-Reinforced, Cellulose-Based Casing

A woven fabric in sheet form with a width of 145 mm, consisting of 100% nylon-6 and with a basis weight of 60 g/m², was used to produce a fabric-reinforced, tubular, cellulose-based food casing. This was done using the viscose method. A viscose solution was applied from the outside to the tube-formed woven fabric; the basis weight of the finished casing was approximately 120 g/m².

### EXAMPLE 7

A self-crosslinking acrylate emulsion according to table 3 was applied to the woven fabric from example 6. The coating amounted to 3%, based on the dry weight of the pure nylon fabric. Viscose solution was applied from the outside to the tube-formed fabric, and the cellulose was regenerated from the viscose. The basis weight of the finished casing was 120 g/m².

### EXAMPLE 8

A woven fabric in sheet form with a width of 145 mm, consisting of 100% polyethylene fibers and with a basis weight of 60 g/m², was used to produce a fabric-reinforced, tubular, cellulose-based food casing. This was done using the viscose method. A viscose solution was applied from the outside to the tube-formed woven fabric. The basis weight of the finished casing was 120 g/m².

### EXAMPLE 9

An adhesion impregnation was applied, using the internal impregnation technique, to a food casing produced as in example 2, prior to the drying of the gel tube. This application was made using a polyamidoamine resin solution available commercially under the name ®Kenores XO from Akzo-Nobel. The application rate of the resin to the finished casing was approximately 300 mg/m².

### EXAMPLE 10

A peel impregnation was applied, using the impregnating technique, to the inside of a food casing produced as in example 2, prior to the drying of the gel tube. This application was made using a chromium-fatty acid complex solution. The chromium-fatty acid complex component is available as ®Montacell CF from H. Costenoble GmbH & Co. KG. The application rate of chromium-fatty acid complex was 0.250 mg/cm² of the finished food casing.

### EXAMPLE 11

An adhesion impregnation was applied, using the internal impregnation technique, to a food casing produced as in example 7, prior to the drying of the gel tube. This application was made using a polyamidoamine resin solution available as ®Kenores XO from Akzo-Nobel. The application rate of the resin to the finished casing was approximately 250 mg/m².

Table 4 reports the viscose penetration times of the fiber reinforcements. The viscose penetration time is similar in the case of all of the examples to that in comparative example 1 (web standard with cellulose basis). In the case of the woven fabrics made from pure nylon or from a purely synthetic nonwoven web it was possible to improve the viscose penetration time by means of a hydrophilicizing agent. In this context it must be ensured, however, that the porosity of woven fabric, knit or nonwoven web is not excessively lowered by the binder in such a way as to prevent viscose penetration.

TABLE 4

| | Viscose penetration |
|---|---|
| Example | [s] |
| 1 | 25 |
| 2 | 30 |
| 3 | 27 |
| 4 | 27 |
| 5 | 32 |
| 6 | 35 |
| 7 | 32 |
| 8 | 39 |

Tables 5 and 6 report the peel ratings for the adhesion of the casing in relation to salami and meat sausage. In this case it becomes clear that the nature of the nonwoven web has no deleterious consequences for the adhesion properties of the casings. By means of the internal impregnation it is possible to exert precise control over the peel properties of the casings.

TABLE 5
Peeling results for salami

Peel ratings after

| Example | 10 days | 6 weeks |
|---|---|---|
| 1 | 1.5 | 0.5-1 |
| 2 | 1 | 0-0.5 |
| 3 | 1 | 0-0.5 |
| 4 | 1 | 0-0.5 |
| 5 | 1 | 0-0.5 |
| 6 | 1 | 0-0.5 |
| 7 | 1 | 0-0.5 |
| 8 | 1 | 0-0.5 |
| 9 | 2.5 | 2.25 |
| 10 | 0 | 0 |
| 11 | 2.5 | 2.0 |

TABLE 6
Peeling results for meat sausage 1 day after cooking

| Example | |
|---|---|
| 1 | 1.75 |
| 2 | 1.5 |
| 3 | 1.5 |
| 4 | 1.5 |
| 5 | 1.5 |
| 6 | 1.5 |
| 7 | 1.5 |
| 8 | 1.5 |
| 9 | 2.25 |
| 10 | 0-1 |
| 11 | 2.25 |

The casings with purely synthetic reinforcement show no adhesion influence on the peel ratings, in contrast to the casing with a cellulose-based fiber reinforcement that has been provided with a polyamidoamine-epichlorohydrin resin binder. These casings, even without being coated internally with an adhesion component, exhibited a moderate adhesion after 10 days. After 6 weeks the peel rating is still evaluated at 0.5 to 1 for the standard casing.

In the case of casings with purely synthetic reinforcement the adhesion without additional internal impregnation was rated at 1 after 10 days of salami ripening, and was rated 0 to 0.5 after 6 weeks. This means that in the case of singly viscose-treated casing types it is frequently possible to forego a peel impregnation, and in the case of a pizza salami application, for which in the majority of cases a low level of adhesion to the casing is required, to forego an additional internal impregnation.

1. A food casing comprising regenerated cellulose with an internal fiber reinforcement, wherein the fiber reinforcement is comprised of synthetic fibers.

2. The food casing of claim 1, wherein the synthetic fibers are comprised of thermoplastics.

3. The food casing of claim 1, wherein the synthetic fibers are bicomponent or multicomponent fibers.

4. The food casing of claim 1, wherein the fiber reinforcement is a nonwoven web, a woven fabric or a knit made from synthetic fibers.

5. The food casing of claim 1, wherein the fiber reinforcement is a nonwoven web, and said nonwoven web is adhesively or cohesively consolidated.

6. The food casing of claim 4, wherein the fiber reinforcement is a nonwoven web, and said nonwoven web is multilayered or multiphase.

7. The food casing of claim 1, wherein the surface of the fiber reinforcement is additionally modified.

8. The food casing of claim 1, wherein the fiber reinforcement is chemically modified.

9. The food casing of claim 1, wherein the fiber reinforcement is a nonwoven web having a dry weight of 10 to 50 g/m².

10. The food casing of claim 1, wherein the fiber reinforcement is a woven fabric, loop-formed knit or loop-drawn knit having a dry weight of 10 to 400 g/m².

11. The food casing of claim 1, wherein the fiber reinforcement has a viscose penetration time of 5 to 120 s, determined using viscose with a falling-ball viscosity of 223 seconds at 25° C.

12. The food casing of claim 1, which comprises, blended with the regenerated cellulose, organic or inorganic dyes or color pigments, polymeric additives, fats or fatlike substances.

13. The food casing of claim 1, which is internally and/or externally impregnated or coated.

14. The food casing of claim 13, which externally has a continuous coating with barrier properties for oxygen and/or water vapor.

15. The food casing of claim 13, which is coated and/or impregnated with liquid smoke, other flavors, biocides, organic or inorganic particles, polyamide-based resins and/or oils or waxes.

16. A process for producing a food casing of claim 1, which comprises the following steps:
(a) providing a viscose spinning solution;
(b) providing an unpretreated or pretreated fiber reinforcement made of synthetic fibers;
(c) forming the fiber reinforcement into a tube with overlapping longitudinal edges;
(d) applying the viscose solution to the tube from the outside, from the inside or from both sides;
(e) regenerating the cellulose from the viscose solution;
(f) washing the cellulose gel tube obtained in step e);
(g) optionally treating the gel tube with a secondary plasticizer;
(h) drying the tubular casing; and
(i) optionally configuring the casing.

17. A process for producing a food casing of claim 1, which comprises the following steps:
a) providing a cellulose spinning solution with an amine oxide as solvent;
b) providing an unpretreated or pretreated fiber reinforcement made of synthetic fibers;
c) forming the fiber reinforcement into a tube with overlapping longitudinal edges;
d) applying a cellulose solution to the tube from the outside, from the inside or from both sides;
e) precipitating the cellulose;
f) washing the cellulose gel tube;
g) optionally treating the cellulose gel tube with a secondary plasticizer;
h) drying the tubular casing; and
i) optionally configuring the casing.

18. An artificial sausage casing or cheese casing comprising the food casing of claim 1.

19. The food casing of claim 2, wherein the thermoplastics are polyolefins or copolymers with olefin units, polyacrylates, copolymers with acrylonitrile units, polyesters, copolyesters, aliphatic or (part-)aromatic polyamides or copolyamides.

20. The food casing of one or more of claim 7, wherein the surface of the fiber reinforcement is additionally modified by exposure to high-energy radiation.

21. The food casing of claim 20, wherein the high-energy radiation is corona discharge, plasma or electron beam.

22. The food casing of claim 8, wherein the chemical modification involves at least one binder.

23. The food casing of claim 9, wherein the fiber reinforcement is a nonwoven web having a dry weight of 15 to 30 g/m².

24. The food casing of claim 10, wherein said dry weight is 25 to 110 g/m².

25. The food casing of claim 11, wherein the viscose penetration time is 10 to 80 s.

26. The food casing of claim 12, wherein the polymeric additives are selected from alginates, copolymers of N-vinylpyrrolidone and dimethylaminomethyl methacrylate or copolymers of N-vinylpyrrolidone and trimethylmethacryloyloxyalkylammonium halide, trimethylmethacryloyloxyalkylammonium alkanesulfonate or trimethylmethacryloyloxyalkyl ammonium sulfate.

27. The food casing of claim 14, wherein the coating comprises polyvinylidene chloride (PVDC) or a vinylidene chloride copolymer.

28. The food casing of claim 17, wherein the solvent is a solution of cellulose in hydrous N-methylmorpholine N-oxide.

29. The artificial sausage casing or cheese casing of claim 18, wherein the sausage is selected from raw-meat sausage, cooked-meat sausage or scalded-emulsion sausage.
